(19) United States
(12) Patent Application Publication
(10) Pub. No.: US 2026/0177746 A1
(43) Pub. Date: Jun. 25, 2026

(54) OPTOELECTRONIC DEVICE COMPRISING A III-V STRUCTURE ON A SUBSTRATE COMPRISING A SILICON WAVEGUIDE

(71) Applicant: COMMISSARIAT A L'ENERGIE ATOMIQUE ET AUX ENERGIES ALTERNATIVES, Paris (FR)

(72) Inventors: Sylvain GUERBER, Grenoble Cedex 09 (FR); Karim HASSAN, Grenoble Cedex 09 (FR); Benoit CHARBONNIER, Grenoble Cedex 09 (FR); Guillaume BRUEL, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 19/424,508

(22) Filed: Dec. 18, 2025

(30) Foreign Application Priority Data
Dec. 20, 2024 (FR) FR2414853

(51) Int. Cl. G02B 6/122; G02B 6/12; G02B 6/13; G02B 6/136

(52) U.S. Cl. CPC G02B 6/1223; G02B 6/1228; G02B 6/131; G02B 6/136; G02B 2006/12061; G02B 2006/12078; G02B 2006/12147

(57) ABSTRACT

An optoelectronic device including a substrate including a silicon waveguide, a III-V structure forming a first waveguide and including a first layer, for example, -n doped, an optically active layer, a second layer, for example, -p doped, and an intermediate layer based on of a III-V material configured to form an effective refraction index waveguide comprised between the effective refraction index of the first waveguide, and the effective refraction index of the silicon waveguide, so as to obtain an optical coupling between the first waveguide and the intermediate waveguide, and an optical coupling between the intermediate waveguide and the silicon-based waveguide.

### TECHNICAL FIELD

The present invention relates to the field of optoelectronics, and more specifically, on silicon substrate optoelectronics. It has a particularly advantageous application in integrating on silicon III-V hybrid structures with a silicon photon guide.

### PRIOR ART

In the field of on silicon integrated optics, waveguides are significant components. They form an optical circuitry, making it possible to interconnect different optoelectronic components. Submicrometric waveguides are, in particular, used in applications linked to optical telecommunications, to photonics, to non-linear optics and to quantum computing.

There are optoelectronic devices, for example, illustrated in FIGS. 2A and 2B, comprising a III-V material-based, optically active structure 12′, and comprising a first layer 13′ (for example, N doped), a quantum well layer, also called active layer 14′, and a second layer 15′ (for example, P doped). The first layer 13′, the quantum well layer, also called active layer 14′, and the second layer 15′ form a first waveguide 12′, also being able to be called active waveguide. The optically active structure 12′, also called III-V structure, is integrated on a substrate 10 comprising a silicon-based waveguide 11′. These devices are, for example, used as an amplifier, modulator, or for light generation purposes, like for example, in lasers.

Typically, for integrating these on silicon III-V hybrid structures, it is sought to perform an optical coupling between the active waveguide and the silicon-based waveguide 11′, for example, buried in a substrate 10′. The substrate 10′ can, for example, be an SOI (Silicon-On-Insulator) substrate.

The optical coupling between the active waveguide and the silicon-based waveguide 11′ is limited by the effective refraction index difference between the active waveguide and the silicon-based waveguide 11′. FIG. 1 illustrates, as an example, the effective refraction index:
n_{eff(15′)} of the active guide 12′ according to the width of the p-InP layer 15′ (also called InP “bar”) in nm,
Δn_{eff(Si500)} of a so-called “thick” silicon-based waveguide 11′ having a core of thickness e₁₁ ′ 500 nm and two side edges, 300 nm thick,
Δn_{eff(Si300)} of a more standard, silicon-based photon waveguide, having a core of thickness 300 nm and two side edges of 150 nm.

FIG. 1 shows a mismatch between the effective refraction indices of an InP rod for a width greater than 500 nm and a silicon-based waveguide with a standard, 300 nm photon core. The transition between the quantum well layer of the optically active InP structure and the silicon-based waveguide remains possible, but for an InP rod width, typically less than 200 nm. The InP rod must therefore be very narrow. This imposes very high manufacturing stresses, which prevent the industrial-scale production of these devices.

To bypass this problem, there are solutions in which a III-V structure is integrated on a thick, silicon-based guide. The document, Duan, G. H., et al. (2014). Hybrid III-V on Silicon Lasers for Photonic Integrated Circuits on Silicon. IEEE Journal of selected topics in quantum electronics, 20(4), 158-120, describes an SOI on substrate InP laser, with a so-called “thick” silicon waveguide, and having a thickness of 440 nm. FIG. 1 indeed shows a good match between the effective refraction indices of an InP rod for a width greater than 750 nm and a thick silicon-based waveguide. Using a thick, silicon-based waveguide however has disadvantages. This type of waveguide indeed is not a standard, photon waveguide, and integrating a III-V structure on this type of waveguide demands reviewing and modifying the silicon part of the manufacturing methods. This therefore complexifies the manufacturing of III-V structures integrated on a silicon-based waveguide.

Document US 2024/061176 A1 describes a structure comprising a first silicon waveguide, on which are formed, respectively, by deposition of a second dielectric SiN, AlN or SiON waveguide 26 and by transferring a III-V structure 40. The optical coupling however remains limited in this structure. The second waveguide indeed does not make it possible to satisfactorily overcome the effective refraction index difference between the active waveguide and the silicon-based waveguide. The on silicon integration of the structure is complex.

Document US 2022/255297 A1 discloses a device comprising a silicon substrate, an SiN waveguide 24, an SiON waveguide 14 laterally coupled to a III-V multilayer stack, the stack being formed by direct on silicon epitaxy. The optical coupling performance remains not very satisfactory, due, in particular, to defects at the interfaces and in the stack.

An aim of the present invention is therefore to propose a solution facilitating the integration of an on silicon hybrid III-V optically active structure, and in particular, such that the integration of the III-V structure is more compatible with the industrial manufacturing constraints.

The other aims, features and advantages of the present invention will appear upon examining the description below, and the accompanying drawings. It is understood that other advantages can be incorporated.

### SUMMARY

To achieve this aim, according to a first aspect, an optoelectronic device is provided, comprising:
a substrate comprising a silicon-based waveguide having an effective refraction index,
an optically active structure, so called “μl-V structure”, based on at least one III-V material, disposed on the substrate, the III-V structure comprising:
   a first layer having a first conductivity of a first type of charge carrier,
   an active layer configured to emit or receive a light radiation, and surmounting the first layer,
   a second layer having a second type of charge carrier, and surmounting the active layer, the first layer, the active layer and the second layer being configured together to form a first waveguide, called “active waveguide” having an effective refraction index.

Advantageously, the III-V structure further comprises an intermediate layer based on a III-V material configured to form an effective refraction index intermediate waveguide, comprised between the effective refraction index of the first waveguide and the effective refraction index of the silicon-based waveguide, the intermediate layer being disposed between the active layer and the silicon-based waveguide, so as to obtain an optical coupling between the first waveguide and the intermediate waveguide, and an optical coupling between the intermediate waveguide and the silicon-based waveguide.

The intermediate layer thus serves as an intermediate waveguide between the active waveguide and the silicon-based waveguide. The intermediate waveguide thus has an intermediate effective refraction index, in order to fill the effective index gap between the active waveguide and the silicon-based waveguide.

The width stress of the second layer is therefore relaxed. Furthermore, thanks to this intermediate optical coupling, it is possible to increase the thickness of the first layer. It is therefore possible to size the III-V structure, more compatibly with an industrial manufacture.

Furthermore, this makes it possible to integrate the III-V structure on a substrate comprising a silicon-based waveguide and of more standard dimensions for photon applications. Typically, the waveguide can be silicon-based and have a core, 300 nm thick. This therefore facilitates the integration of the III-V structure by minimising, and preferably by avoiding, the adaptations of the methods for manufacturing the substrate.

The existing solutions implement a dielectric or semiconductor material intermediate layer, formed by deposition (from among SiₓN_{y}, AlN, SiON, a-Si, p-Si, Al₂O₃, polymers, for example) on the substrate comprising the silicon-based waveguide, which does not make it possible to obtain an effective refraction index of the intermediate layer comprised between the effective refraction index of the first waveguide and the effective refraction index of the silicon-based waveguide. There is no longer any III-V material making it possible to obtain an intermediate effective refraction index which can be integrated by a deposition technique, for example, by epitaxy, on the Si substrate without causing defects that are damaging to the optical coupling.

Due to the transfer of the III-V structure, it is possible to use a material coming directly from the III-V structure for the intermediate layer, making it possible to obtain an effective refraction index comprised between the effective refraction index of the first waveguide and the effective refraction index of the silicon-based waveguide. The transfer further makes it possible to avoid temperature stresses with respect to the substrate comprising the silicon-based waveguide.

A second aspect relates to a method for manufacturing an optoelectronic device according to the first aspect, the method comprising:
a provision of the III-V structure,
an integration by transfer of the III-V structure onto the substrate comprising the silicon-based waveguide.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIG. 1 represents the variation of the effective refraction index for the elements of an optoelectronic device according to the prior art.

FIGS. 2A and 2B represent a respectively longitudinal and transverse cross-sectional view of an optoelectronic device according to the prior art.

FIG. 3 represents the variation of the effective refraction index for the elements of an optoelectronic device according to an example of an embodiment of the invention.

FIGS. 4A and 4B represent a respectively longitudinal cross-sectional view and a top view of an optoelectronic device according to an example of an embodiment of the invention.

FIGS. 5A and 5B are diagrams, respectively of the stressed gap energy of the stress S, and of the refraction index according to the gap energy, in an InGaAsP layer.

FIG. 6 represents a cross-sectional view of the optoelectronic device illustrated in FIGS. 4A and 4B.

FIG. 7 represents a top view of the optical transition zones of the optoelectronic device illustrated in FIGS. 4A and 4B, as well as the distribution of the optical mode obtained by simulation of the corresponding device, along several cross-sectional planes.

FIG. 8 represents a longitudinal cross-sectional view of the optical transition zones of the optoelectronic device illustrated in FIGS. 4A and 4B.

FIGS. 9A and 9B represent the distribution of the optical mode obtained by simulation of the optoelectronic device according to the example of FIG. 8, along a longitudinal, cross-sectional plane, and for two p-InP rod widths.

FIG. 10 represents the confinement factor CF of the optical mode in the active layer comprising multi quantum wells MQW, and in an InGaAsP intermediate layer, according to the thickness of the intermediate layer and according to an example of an embodiment of the device.

FIGS. 11A and 11B represent the distribution of the optical mode obtained by simulation of the optoelectronic device according to the example of FIG. 10 along a cross-sectional plane, and for two thicknesses of the intermediate layer.

FIGS. 12A and 12B represent the transmission percentage by optical coupling in, respectively, the first and second optical transition zones, according to the length of the transition zones, according to an example.

FIGS. 13A to 13C represent optimisation graphs of geometric parameters of the optoelectronic device, according to an example.

FIGS. 14A to 14C represent respectively top, cross-sectional and longitudinal cross-sectional views of the device according to another example of an embodiment.

FIGS. 15A to 15D represent longitudinal cross-sectional view of steps of the method for manufacturing the optoelectronic device, according to an example.

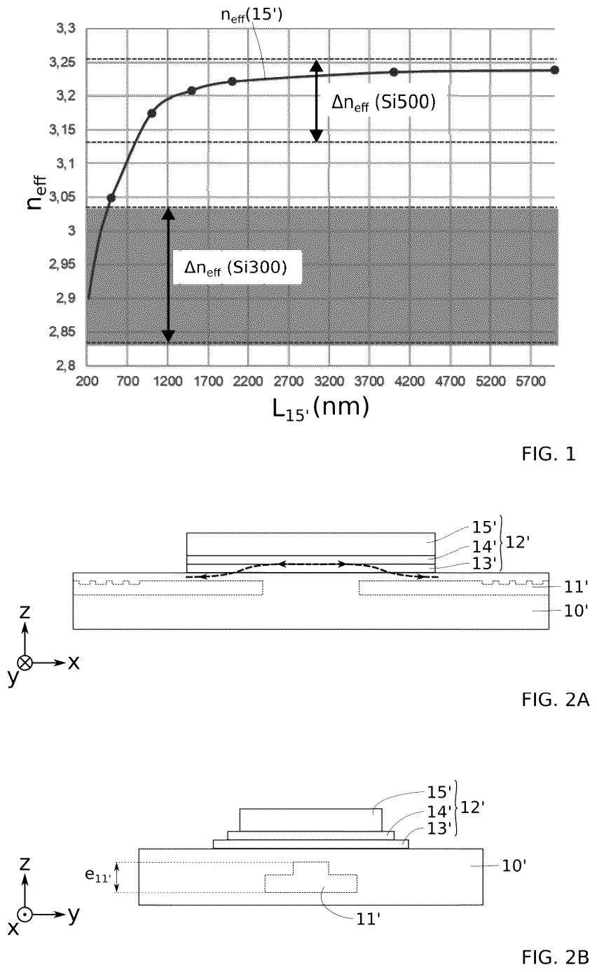

The drawings are given as examples and are not limiting of the invention. They constitute principle schematic representations, intended to facilitate the understanding of the invention, and are not necessarily to the scale of practical applications. In particular, the relative dimensions of the layers, portions, structure, substrate or other elements of the device are not representative of reality.

### DETAILED DESCRIPTION

Before starting a detailed review of embodiments of the invention, optional features are stated below, which can optionally be used in association or alternatively.

According to an example, the second layer extends into a main extension plane and has at least one dimension in said plane, greater than or equal to 500 nm, preferably greater than or equal to 700 nm, and preferably, 1 μm. According to an example, the second layer extends into a main extension plane and has at least one dimension in said plane less than or equal to 4 μm. More preferably, this dimension is substantially equal to 2 μm. Thus, the width of the second layer, or equivalently, of the III-V rod, can be compatible with industrial scale manufacturing methods. This facilitates, in particular, the transfer of the III-V structure onto the substrate.

According to an example, the effective refraction index of the intermediate waveguide is strictly less than the effective refraction index of the first waveguide outside of the first transition zone. According to an example, the effective refraction index of the intermediate waveguide is strictly greater than the effective refraction index of the silicon-based waveguide outside of the second transition zone.

According to an example, the intermediate layer is based on, or constituted of, a material having a refraction index of between 3.2 and 3.5. During the development of the invention, it has been highlighted that this refraction index range limits the absorption of light through the intermediate layer, while enabling the intermediate coupling of the active waveguide to the silicon-based waveguide.

According to an example, the intermediate layer has a thickness e₁₆ greater than or equal to 100 nm. With a thickness greater than 100 nm, the thickness of the intermediate layer is sufficient to perform the intermediate optical coupling, and can be reproduced with standard layer growth techniques.

According to an example, the intermediate layer has a thickness e₁₆ less than or equal to 250 nm. A thickness less than 250 nm enables a concentration of light in the active layer comprising the quantum wells, rather than in the intermediate layer.

According to an example, the intermediate layer is based on, or constituted of, InGaAsP. During the development of the invention, it has been highlighted that this material limits the absorption of radiation, in particular, in the infrared range.

According to an example, the intermediate layer is based on, or constituted of, InGaAlAs and/or InGaAs, and/or InGaAsP. These materials limit the absorption of radiation, in particular in the infrared field.

InGaAsP, InGaAlAs and InGaAs further have a satisfactory lattice match with the III-V material of the active layer. This minimises the defects at their interface.

According to an example, the first layer, the active layer and the second layer are based on, or constituted of, InP.

According to an example, InGaAsP is of the formula In₁₋GaₓAs_{y}P_{1-y} with x between 0.1 and 0.4, preferably substantially equal to 0.4, and including between 0.1 and 0.8, preferably substantially equal to 0.8. This composition makes it possible to maximise the refraction index of the intermediate layer, while limiting its absorption, in particular, in the infrared range, for a non-stressed layer. This material is therefore particularly adapted to improve the coupling by the intermediate waveguide.

According to an example, the first layer comprises a first sublayer and a second sublayer surmounting the first sublayer, the intermediate layer being interposed between the first and second sublayers. The intermediate layer is, in this case, disposed within the first layer, between the first and second sublayers. This arrangement makes it possible to best distribute the distance between the active layer, the intermediate layer and the silicon-based waveguide, to improve the optical couplings. The manufacture of the device is simplified by limiting the adaptation of the current methods. In particular, a transfer of the III-V structure onto the substrate through the first layer is kept, like usual, and not through an intermediate layer, being able to be based on another material.

According to an alternative example, which the intermediate layer is disposed at the interface between the first layer and the substrate.

According to an example, which the intermediate layer is disposed between the active layer and the substrate.

According to an example, the first sublayer has a thickness e₁₃₀, the second sublayer has a thickness e₁₃₁, e₁₃₁ being strictly greater than e₁₃₀. Thus, the intermediate layer is off-centre with respect to the first layer. It has been highlighted that this limits the light losses with respect to a centred configuration (where e₁₃₁ is substantially equal to e₁₃₀) for one same thickness of the first layer.

According to an example, between a first interface between the active layer and the first layer and a second interface between the first layer and the substrate, the first layer has a thickness e₁₃ of between 500 nm and 1500 nm, and preferably substantially equal to 1 μm. This thickness, in particular, plays on the distance between the active layer, the intermediate layer and the silicon-based waveguide. This thickness enables a good optical coupling between the active waveguide, the intermediate waveguide and the silicon-based waveguide, while limiting the light losses. Furthermore, this thickness improves the thermal dissipation and decreases the access resistance of the optically active structure. This thickness facilitates the manufacture of the III-V structure, by relaxing, in particular the stresses on the etching parameters of the initial stack.

According to an example, a first portion of the intermediate layer is at least partially superimposed with a portion of the active layer at a first optical transition zone, the first portion of the intermediate layer and the portion of the active layer, each having a width L₁₆, L₁₄, in their main extension plane, decreasing along the first optical transition zone, along a coupling direction, parallel or combined with the main extension direction of the silicon-based waveguide by moving away from the III-V structure, the first optical transition zone having a length L1 greater than or equal to 100 μm along the coupling direction.

According to an example, a second portion of the intermediate layer is at least partially superimposed with a portion of the silicon-based waveguide at a second optical transition zone, the second portion of the intermediate layer and the portion of the silicon-based waveguide each having a width L₁₆, L₁₁, in their main extension plane, such that:
the width L₁₆ of the second portion of the intermediate layer is decreasing, and
the width L₁₁ of the portion of the silicon-based waveguide is increasing, along the second optical transition zone by moving away from the III-V structure along the coupling direction, the second optical transition zone having a length L2 greater than or equal to 200 μm along the coupling direction.

In the scope of this so-called “tapered” geometry, these lengths enable a transmission, by successive optical couplings, greater than 99% of light.

According to an example, the device is a laser, an optical amplifier or an optical modulator or a photodetector.

According to an example, the device is configured to emit or receive a radiation in the infrared light range, and for example, of wavelength of between 800 nm and 2 μm.

According to an example, the first layer has an “n” type conductivity, the charge carriers being electrons.

According to an example, the second layer has a “p” type conductivity, the charge carriers being holes.

According to an example, the method comprises a sizing of the intermediate layer, the sizing comprising:
a determination of a dimension L₁₅ of the second layer in its main extension plane (x,y), said dimension being greater than or equal to 500 nm, preferably between 700 nm and 20 μm,
the intermediate layer having a thickness e₁₆, a determination of the thickness e₁₆ according to the dimension L₁₅ of the second layer in its main extension plane,
   and the provision of the III-V structure comprises:
an epitaxial growth of the intermediate layer, such that the intermediate layer has the determined thickness e₁₆.
an etching of the second layer, such that the second layer has the determined dimension L₁₅.

It is noted that outside of the transition zones, or equivalently, optical coupling, the III-V rod can be a lot wider, typically the III-V rod can have a width of a few tens of μm.

According to an example, the method comprises a sizing of the first layer, the sizing comprising:
a determination of a thickness e₁₃ of the first layer, taken between a first interface between the active layer and the first layer and a second interface between the first layer and the substrate, enabling the transfer of at least 90% of light between the active waveguide and the intermediate waveguide and between the intermediate waveguide and the silicon-based waveguide,
   and in which the provision of the III-V structure comprises:
an epitaxial growth of the first layer such that, after transfer, the active layer and the substrate are separated from the determined thickness e₁₃.

Fully conventionally, a structure based on a III-V material is a structure comprising, or constituted of, a material comprising at least one species of the III column of the periodic table, and at least one species of the V column of this table.

Likewise, the following abbreviations relating to a material M are optionally used:
u-M, or equivalently i-M, refers to the intrinsic or unintentionally doped material M, according to the terminology usually used in the microelectronics field for the prefix u- or equivalently i-,
n-M refers to the N, N+ or N++ doped material M, according to the terminology usually used in the microelectronics field for the prefix n-,
p-M refers to the P, P+ or P++ doped material M, according to the terminology usually used in the microelectronics field for the prefix p-,

By a substrate, a film, a layer “based on” a material M, this means a substrate, a film, a layer comprising this material M only or this material M and optionally other materials, for example, alloy elements, impurities or doping elements. If necessary, the material M can have different stoichiometries.

Several embodiments of the invention implementing successive steps of the manufacturing method are described below. Unless explicitly mentioned, the adjective “successive” does not necessarily imply, even if this is generally preferred, that the steps immediately follow one another, intermediate steps being able to separate them.

Moreover, the term “step” means the carrying out of a part of the method, and can mean a set of substeps.

Moreover, the term “step” does not compulsorily mean that the actions carried out during a step are simultaneous or immediately successive. Certain actions of a first step can, in particular, be followed by actions linked to a different step, and other actions of the first step can then be resumed. Thus, the term “step” does not necessarily mean single and inseparable actions over time and in the sequence of the phases of the method.

It is specified that in the scope of the present invention, the thickness of a layer or of the substrate is measured along a direction perpendicular to the surface, along which this layer or this substrate has its maximum extension. The thickness is thus taken along a direction perpendicular to the main faces of the substrate on which the different layers rest. Thus, a layer typically has a thickness along z, when it extends mainly along a plane xy. The relative terms “on”, “under”, “underlying” preferably refer to positions taken along the direction z.

Below, the length is taken along the direction x, the width is taken along the direction y, and the height and the etching depth are taken along the direction z.

It is specified that, in the scope of the present invention, the terms “on”, “surmounts”, “covers”, “opposite” and their equivalents do not necessarily mean “in contact with”. Thus, for example, the deposition, the transfer, the bonding, the assembly or the application of a first layer on a second layer, does not compulsorily mean that the two layers are directly in contact with one another, but means that the first layer covers, at least partially, the second layer, by being either directly in contact with it, or by being separated from it by at least one other layer or at least one other element. By “in contact” or “in contact with”, this means that a thin interface can exist, for example, caused by the manufacturing variability.

It is specified that, in the scope of the present invention, a third layer inserted between a first layer and a second layer does not compulsorily mean that the layers are directly in contact with one another, but means that the third layer is either directly in contact with the first and second layers, or separated from these, by at least one other layer or at least one other element, unless it is disposed otherwise.

By “superimposed” layers, or portions, or zones, in this case, this means layers, or portions, or zones are in contact along their main extension plane and disposed on top of one another along the direction of the stack, this direction being perpendicular to the main extension plane.

The dimensional values extend close to the manufacturing and measuring tolerances.

The terms “substantially”, “around”, “about” mean “plus or minus 10%” or, when this is an angular orientation, “plus or minus 10°”. Thus, a direction substantially normal to a plane means a direction having an angle of 90±10° with respect to the plane.

In the scope of the invention, the energies are given in electronvolts, for which 1 eV≈1.602.10⁻¹⁹ J, in the international unit system.

For flat light waves in homogenous media (for example, in optical materials), the refraction index n can be used to quantify the increase of the number of waves (phase change by length unit) caused by the medium: the number of waves is n times greater in the vacuum.

The effective refraction index has a similar meaning for the propagation of light in a restricted transverse extension waveguide: the value p (phase constant) of the waveguide (for a certain wavelength) is the effective refraction index multiplied by the number of waves in the vacuum, according to the following expression:

$$β = {n}_{eff} \frac{2 π}{λ}$$

The expression “A and/or B” means (A), (B), or (A and B). The expression “A, B and/or C” means (A), (B), (C), (A and B), (A and C), (B and C), or (A, B and C).

The invention will now be described in detail through a few non-limiting examples of embodiments. The optoelectronic device 1 according to the invention can, for example, be used as an amplifier, modulator, for purposes of detecting light as a photodetector, or for purposes for generating light and, for example, for a laser.

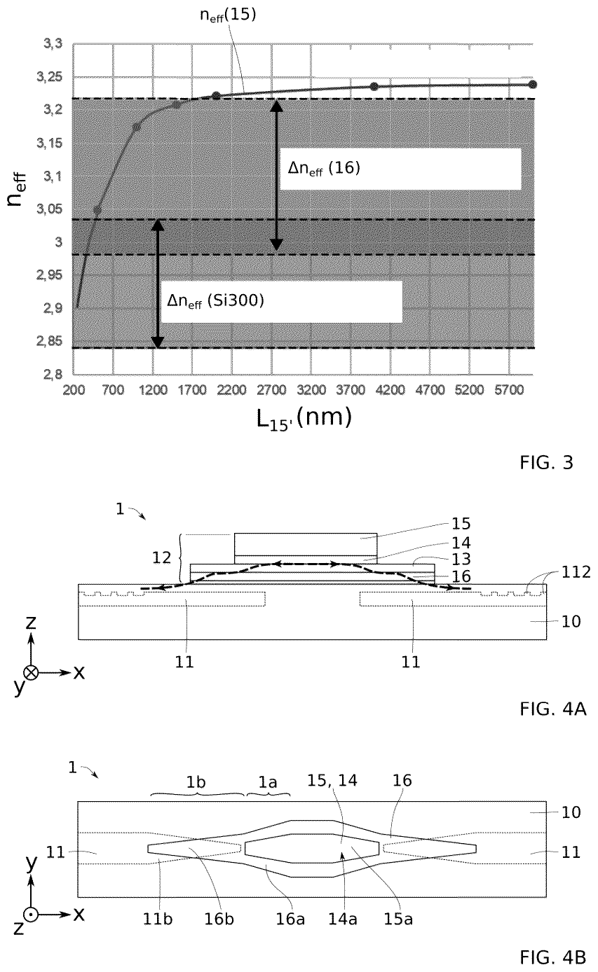

FIGS. 3, 4A and 4B illustrate an example of an optoelectronic device according to the invention.

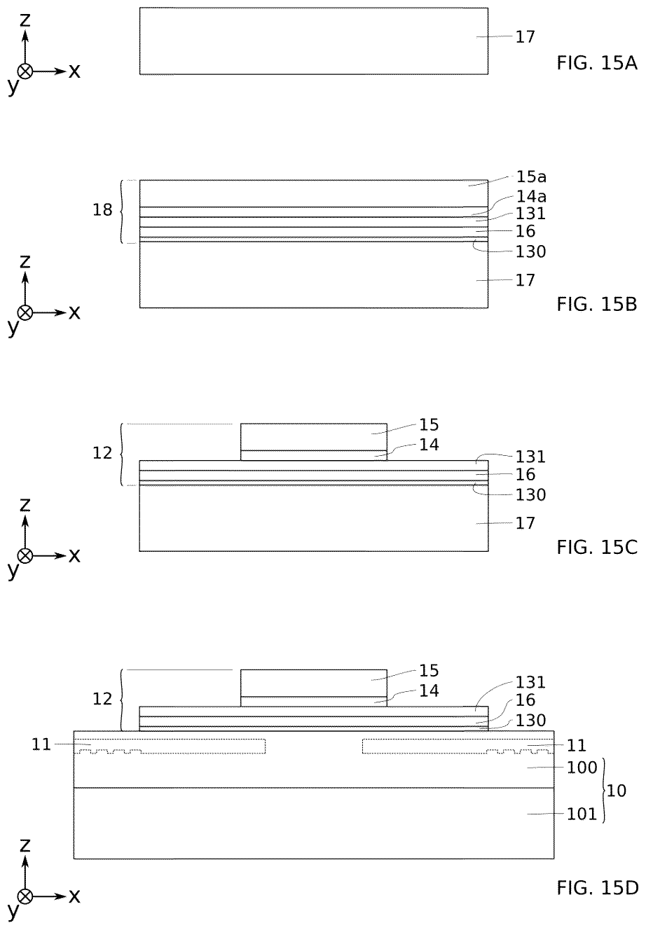

The optoelectronic device 1 comprises a substrate 10. The substrate 10 can, for example, be an SOI-type substrate. The substrate 10 comprises a waveguide 11 based on, or constituted of, silicon Si. Below, this waveguide is called “Si waveguide 11”. The Si waveguide 11 can be buried in a portion 100 based on, or constituted of, SiO₂ of the substrate 10 (as illustrated in FIG. 15D). In a known manner, the Si waveguide can have raised elements 112, and/or at least one filter, and/or a diffraction array, and/or internal total reflection elements.

The Si waveguide 11 typically extends continuously along a direction x. It thus guides the propagation of the light radiation along x. The Si waveguide 11 can have, in a cross-section, different shapes. Below, an edged waveguide is described. It is noted that other waveguide geometries, for example, sloped or periodic arrayed, are possible. The sizing methods described then can absolutely be adapted to other geometries of the waveguide. In the accompanying drawings, only one cross-section of the Si waveguide 11 in the planes yz and xz is represented. This cross-section is not however necessarily constant along x, along the Si waveguide 11.

The optoelectronic device 1 further comprises an optically active structure 12 based on, or constituted of, at least one III-V material. The III-V structure 12 comprises a first layer 13 having a first conductivity of a first type of charge carrier. For example, the first layer is “N” doped, the charge carriers being electrons. The III-V structure 12 comprises a second layer 15 having a second conductivity of a second type of charge carrier. For example, the second layer is “P” doped, the charge carriers being holes. The III-V structure 12 comprises an active layer 14 configured to emit or receive a light radiation. The active layer 14 comprises, for this, quantum wells. The active layer 14 can also be called MQW (multi quantum well). The layer 14 is inserted between the first 13 and second 15 layers. The layers 13, 14, 15 form a first waveguide, being able to be called “active waveguide”. In the III-V structure, the second layer 15 and the active layer 14 generally have at least one dimension in the plane xy, and in particular, the width L₁₅ along the direction y, less than the corresponding dimension of the first layer 13. The second layer 15 and the active layer 14 can thus form what it called a III-V rod.

According to an example, the optoelectronic device 1 is configured to perform in the infrared range. For example, the working wavelength of the electronic device 1 is substantially of between 800 nm and 2 μm, and preferably substantially equal to 1.55 μm.

In order to be able to fill the gap between the effective refraction index range Δn_{eff(Si300)} of an Si waveguide, and in particular, of thickness substantially equal to 300 nm according to photon standards, and the effective refraction index of the III-V rod n_{eff(15)}, the optoelectronic device 1 comprises an intermediate layer 16 forming an intermediate waveguide enabling an optical coupling, on the one hand, between the active waveguide and the intermediate waveguide 16, and on the other hand, the intermediate waveguide 16 and the Si waveguide 11. As illustrated in FIG. 3, the waveguide formed by the intermediate layer 16, also called intermediate waveguide 16, can have an effective index range in an intermediate range Δn_{eff(16)} at the effective refraction indices of the Si waveguide 11 and of the III-V rod. This makes it possible to relax the sizing stress on the width L₁₅ of the III-V rod.

For these optical couplings, the intermediate layer 16 is disposed between the active layer 14 and the Si waveguide 11. As FIG. 4B illustrates, for the coupling between the intermediate waveguide 16 and the active waveguide, a first portion 16a of the intermediate layer 16 can be at least partially superimposed along the direction z, with a portion 14a of the active layer 14. This forms a first transition zone 1a. For the coupling between the intermediate waveguide 16 and the Si waveguide 11, a second portion 16b of the intermediate layer 16 and a portion 11b of the Si waveguide 11 can be at least partially superimposed along the direction z. This forms a second transition zone 1b.

The layers of the III-V structure 12 are at least partially superimposed together.

According to an example, the III-V structure 12 is InP-based. According to this example, the first layer 13 is a layer based on or constituted of n-InP and the second layer 15 is a layer based on or constituted of p-InP. The active layer 14 can be an i-InP-based layer. The active layer 14 can be based on or constituted of at least one ternary or quaternary alloy comprising InP and of another element chosen from among Ga, As, Al, and/or P, for example. The layer 14 can, for example, be based on or constituted of InGaAsP or InGaAsAl. The layer 14 can be intrinsic, and therefore not be doped. Below, it is considered, in a non-limiting manner, that the III-V structure 12 is InP-based. It is noted that other III-V materials are possible. In particular, the processes of choosing materials and sizings described below can absolutely be applied to other III-V materials.

The materials of the intermediate layer 16 preferably has a lattice match with the III-V material of the III-V structure 2. The material of the intermediate layer 16 preferably has a limited absorption at the working wavelength. The layer 16 can be based on or constituted of at least one ternary or quaternary alloy comprising InGaAs and another element chosen from among Al, and/or P, for example. The layer 16 can, for example, be based on or constituted of InGaAsP, InGaAlAs and/or InGaAs. In the case of InP, the InGaAsP material is chosen, as it has a low absorption at the working wavelength of 1.55 μm (and in particular, with respect to the InGaAs material, for example).

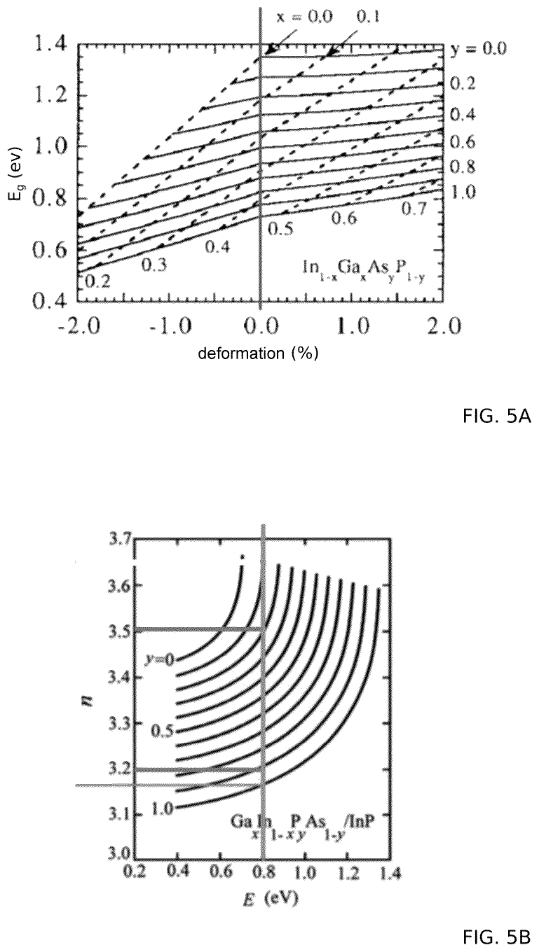

The In₁₋ₓGaₓAs_{y}P_{1-y} composition can be chosen according to the following process. By using the diagrams illustrated in FIGS. 5A (Adachi —2009 —Properties of Semiconductor Alloys Group-IV, III-V and II-VI semiconductors) and 5B (Minch Park —1999—Theory and experiment of InGaAsP and InGaAlAs long-wavelength strained) first, in the x-axis, 0% of FIG. 5a is placed, in order to have a non-stressed intermediate layer 16. For a working wavelength of 1.55 μm, the corresponding gap energy E_{g} is preferably greater than or equal to 0.8 eV to avoid the absorption. According to FIG. 5A, the intersection between E_{g}=0.8 eV and the y value for an x-axis of 0% therefore implies that y is less than or equal to substantially 0.8. With FIG. 5B, the refraction index n of the material can be determined according to the composition of the material and the energy E of the photon. By reporting this value of y on the graph of FIG. 5B (for which the y and 1-y values are inverted with respect to FIG. 5A), y is obtained, greater than or equal to 0.2. In FIG. 5B, the intersection between the composition line y=0.2 and E=0.8 eV, and the intersection between the composition line y=1 and E=0.8 eV give a refraction index substantially between substantially 3.17 and 3.5.

The intersection between the 0% stress x-axis in FIG. 5A, and the y composition line can give the x value. For example, for y=0.8, x is substantially equal to 0.4.

According to the In₁₋ₓGaₓAs_{y}P_{1-y} composition as described in FIG. 5A:
x non-zero and preferably between 0 and 0.4, and/or
y non-zero and less than or equal to 0.8, and preferably between 0.1 and 0.8.

To maximise the gap energy and limit the light absorption at the working wavelength, it can be preferable to limit the refraction index of the material. If a high gap energy is targeted, the refraction index of InGaAsP will, for example, be minimised (n tends, for example, towards 3.2). Yet, using a low refraction index implies thickening the intermediate layer 16, which can make the optical coupling with the other guides more difficult. The optimisation of the sizing of the device can depend on targeted applications.

To preserve thin layer thicknesses, a high refraction index is preferable. In order to find a compromise between these effects, the intermediate layer 16 preferably has a refraction index substantially equal to 3.5. This favours the coupling, while keeping a reasonable thickness of the intermediate layer 16.

Preferably, the composition is In_{0.6}Ga_{0.4}As_{0.3}P_{0.2} to have a refraction index substantially equal to 3.5.

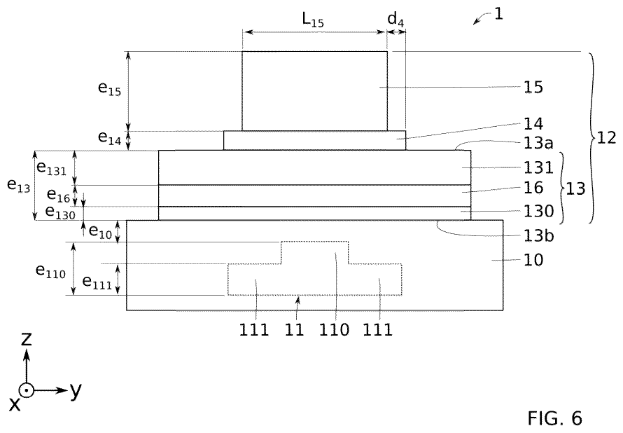

Particular sizing and geometry examples are then described in reference to FIGS. 6 to 13C.

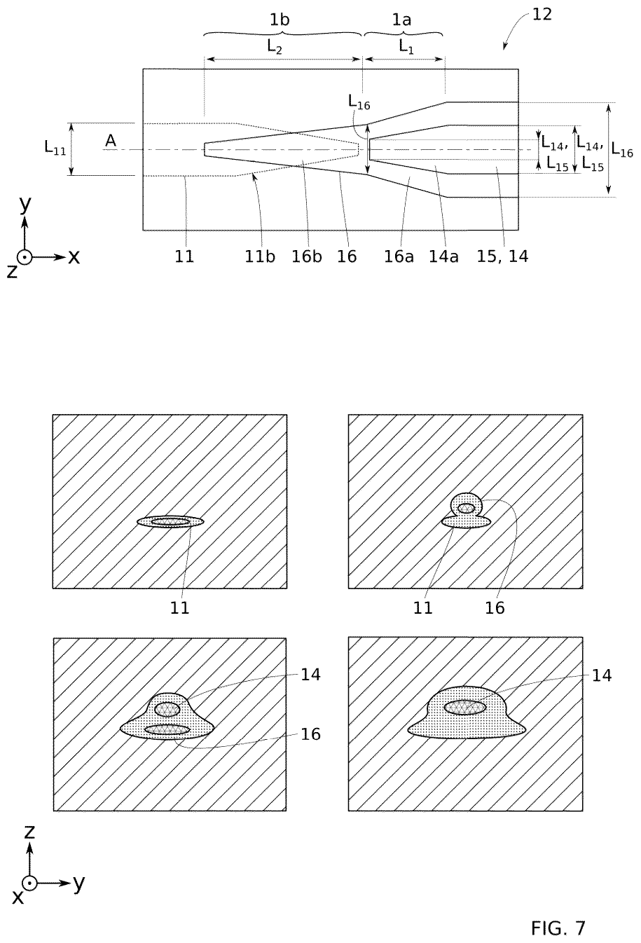

According to a first example illustrated in FIGS. 6 and 7, the device 1 comprises the SiO₂-based substrate 10, in which an Si waveguide 11 is buried. The Si waveguide 11 has a central part 110 having a thickness substantially equal to 300 nm. The central part 110 is framed along the direction y by two edges 111 having a thickness substantially equal to 150 nm. The central part 110 can be surmounted by a portion of the substrate 10 having a thickness e₁₀ substantially equal to 100 nm.

The III-V structure 12 is disposed on the substrate 10. In the III-V structure 12, the intermediate layer 16 is preferably disposed within the first layer 13. Thus, the first layer 13 comprises a first sublayer 130 and a second sublayer 131, the intermediate layer 16 being inserted between the first sublayer 130 and the second sublayer 131.

As illustrated in FIG. 7, to make the optical coupling at the first 1a and second 1b transition zones, the optoelectronic device 1 can have a so-called “tapered” configuration. In a tapered configuration, at least one dimension in the plane xy, and for example, the width y, of the active layer 14, of the intermediate layer 16 and of the Si waveguide 11, is increasing or decreasing, preferably strictly, on each transition zone 1a, 1b, along a coupling direction A and by moving away from the III-V structure (direction −x in FIG. 7). The coupling direction can be parallel, and preferably combined, with the main extension direction of the Si waveguide 11. Below, the increasing and decreasing notions are considered along the coupling direction A and by moving away from the III-V structure (direction −x in FIG. 7). In a tapered configuration, at least one dimension in the plane xy, and for example, the width y, of the active layer 14, of the intermediate layer 16 and of the Si waveguide 11, is increasing or decreasing, preferably strictly, over at least 50% and preferably at least 90% and preferably over the entirety of each transition zone 1a, 1b, along a coupling direction A and by moving away from the III-V structure.

More specifically, at the first transition zone 1a, the active layer 14, optionally the second layer 15, has a width L₁₅ linearly decreasing between a first width and a second width, for example, from 2 μm to 500 nm. The intermediate layer 16 has, according to this example, a width L₁₆ linearly decreasing between a first width and a second width, for example, between 6 μm and 2 μm. Preferably, the intermediate layer 16 and the active layer 14 are centred along the coupling direction A at least at the first transition zone 1a. The width variation zone of the active layer 14 and of the intermediate layer 16 can extend along the direction x over a length L1.

According to an example, at the second transition zone 1b, the intermediate layer 16, has a width L₁₆ linearly decreasing between a first length and a second length, for example, from 2 μm to 500 nm. According to an example, the decreasing of the width L₁₆ of the intermediate layer 16 is in continuity from the first transition zone 1a to the second transition zone 1b. The Si waveguide 11 can have, according to this example, a width L₁₁ linearly increasing between a first width and a second width, for example, between 500 nm and 2 μm. Preferably, the intermediate layer 16 and the Si waveguide 11 are centred along the coupling direction A at least at the first transition zone 1b. The width variation zone of the Si waveguide 11 and of the intermediate layer 16 can extend along the direction x over a length L2.

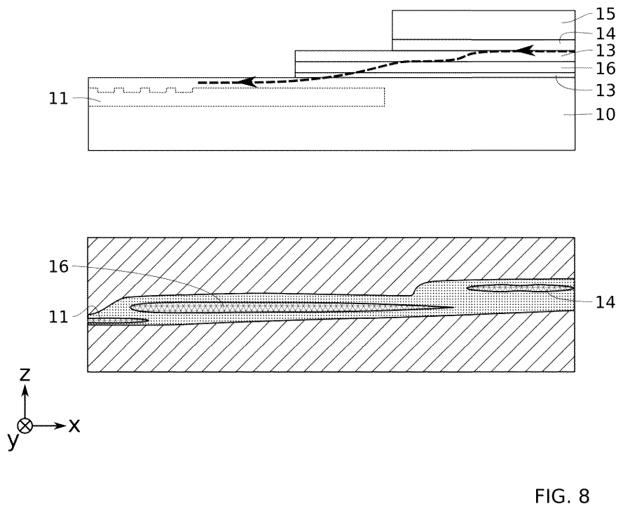

As illustrated by FIGS. 7 and 8, the optical coupling between the active waveguide and the intermediate waveguide 16, then between the intermediate waveguide 16 and the Si waveguide 11, has been modelled for the geometry illustrated in FIGS. 6 and 7. In FIG. 7, several cross-sectional planes can be seen in the plane yz, which shows the successive passages of light from the active layer 14 to the Si waveguide 11. FIG. 8 illustrates this, along a longitudinal cross-sectional plane xz.

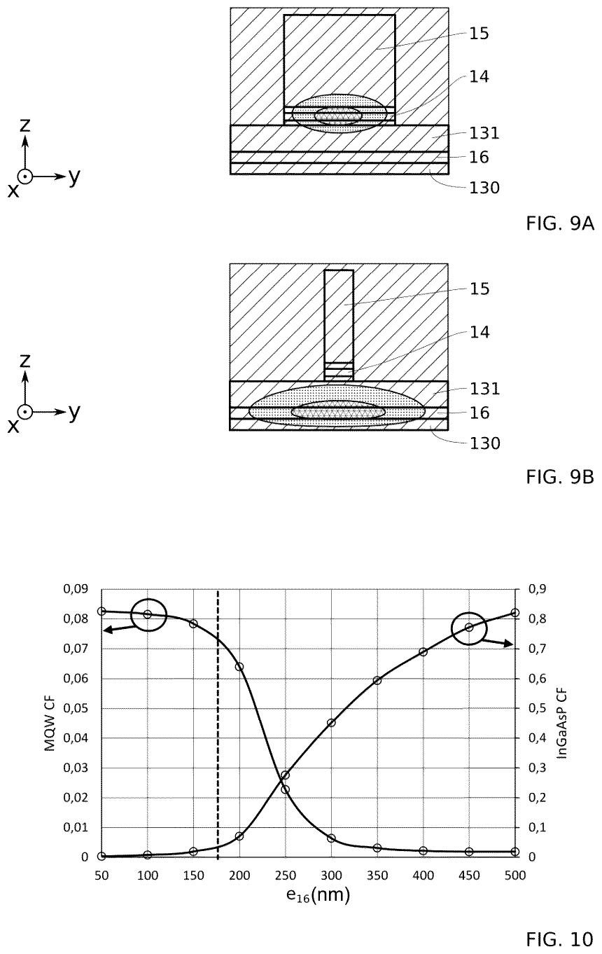

The second layer 15 and the active layer 14 are generally etched to form the III-V rod. The second layer 15 can therefore have a width L₁₅ taken along the direction y. The optical transitions in the active layer 14 are typically governed by the width L₁₅, as FIGS. 9A and 9B illustrate, for respectively L₁₅=4 μm and L₁₅=0.5 μm. According to an example, in order to concentrate light in the active layer 14, and second layer 15 has a width L₁₅ greater than 500 nm, and preferably of between 2 μm and 4 μm. In this case, the widest width L₁₅ of the III-V rod is considered, outside of the optical transition zone. The active layer 14 can have the same width as that of the second layer 15. Alternatively, as illustrated in FIG. 6, the active layer 14 can have an overhang, preferably on either side of the second layer 15. This overhang can extend over a distance d₁₄ taken along the direction y, for example, substantially equal to 200 nm.

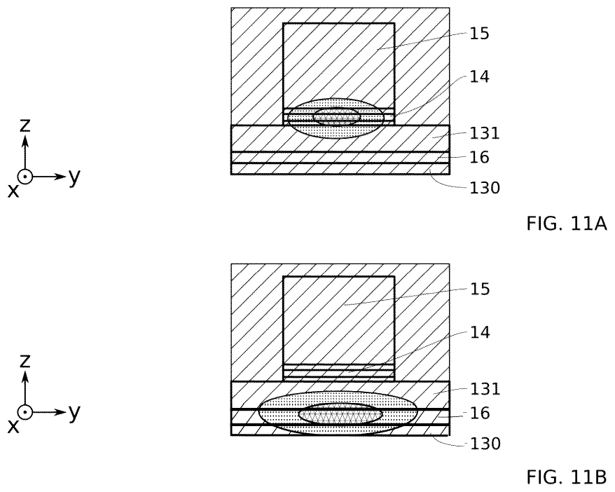

The width L₁₅ is interdependent with the thickness e₁₆ of the intermediate layer 16. Light is sought to be concentrated in the active layer 14. As illustrated in FIGS. 10 and 11A, according to the width L₁₅ chosen, the maximum thickness of the intermediate layer 16 can be fixed. For a width L₁₅ of the second p-InP layer 15 substantially equal to 4 μm, and an intermediate InGaAsP layer 16 of refraction index n=3.5 disposed at 200 nm from the lower interface 13b between the substrate 10 and the first sublayer 130, a prevalence of light can be observed in the intermediate layer 16 from a thickness e₁₆ greater than 250 nm (for example, as illustrated in FIG. 11B for a thickness e₁₆ of 350 nm). Therefore, a thickness e₁₆ less than or equal to 250 nm, and preferably substantially equal to 175 nm is chosen, in order to concentrate light in the active layer 14. FIG. 11A shows, as an example, a prevalence of light in the active layer 14 for a thickness e₁₆ of 100 nm).

The more it is sought to decrease the thickness e₁₆ of the intermediate layer, the more its effective refraction index will drop, and therefore the more the width L₁₅ of the second layer 15 must be decreased. It is therefore understood that a compromise can be found, due to this interdependence.

Moreover, the active layer 14 and the intermediate layer 16 are preferably sufficiently moved away from one another to enable a maximum optical coupling and minimise the coupling losses. This can make it possible to limit the width L₁₅ of the second layer 15. This further makes it possible to relax the stresses on the step of etching the III-V rod. Indeed, a problem often encountered and an overetching of the III-V rod leading to an etching of the first layer 13. With a greater thickness of the first layer 13, an etching of this layer 13 will have a moderate impact, in particular on the access resistance of the optoelectronic device. For this, and in reference to FIG. 6, for example, the total thickness e₁₃ of the first layer, taken between a first interface 13a with the active layer 14 and a second interface 13b with the substrate 10, can be substantially equal to 1 μm.

The active layer 14 and the Si waveguide 11 can be spaced apart by a distance, taken along the direction z, substantially perpendicular to the main extension plane of the active layer 14, of between 800 nm and 1200 nm, and preferably substantially equal to 1100 nm.

Furthermore, it has been observed that the coupling losses were further reduced, by offsetting the intermediate layer 16 downwards within the first layer 13. For example, the thickness ratio e₁₃₁/e₁₃₀ can be between 2.5 and 3.5. According to an example, the thickness e₁₃₀ of the first sublayer 130 is substantially equal to 200 nm. Thus, with a thickness e₁₀ substantially equal to 100 nm, the distance between the intermediate layer 16 and the Si waveguide 11 can be substantially equal to 300 nm. According to an example, the thickness e₁₃₁ of the second sublayer 131 can be substantially equal to 625 nm.

According to an example, the thickness e₁₄ of the active layer 14 can be substantially between 200 nm and 500 nm. According to an example, the thickness e₁₅ of the second active layer 15 can be substantially between 1 μm and 3 μm.

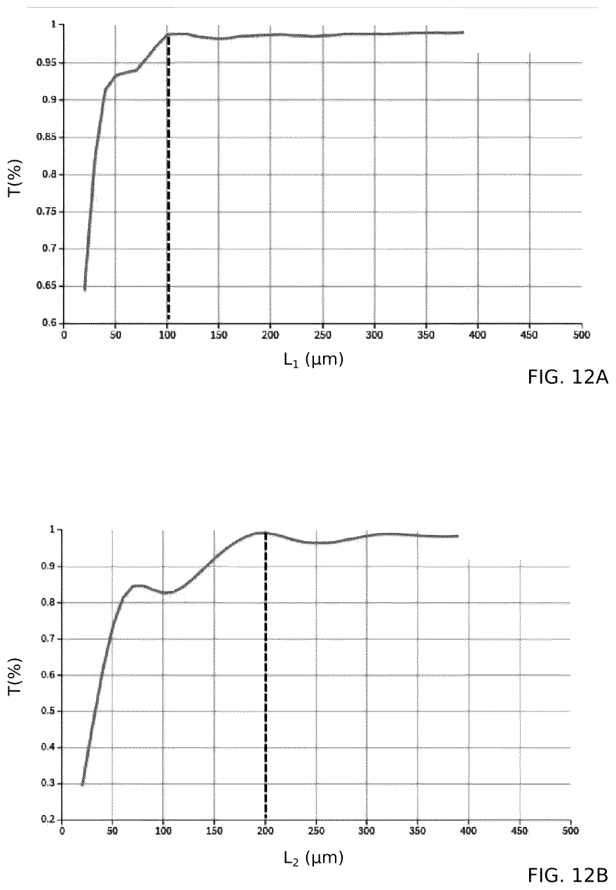

For example, and in reference to FIGS. 7, 12A and 12B, the length, taken along x, optical transition zones 1a, 1b can be adapted to maximise the transmission of light between respectively the active layer 14 and the intermediate layer 16, and the intermediate layer 16 and the Si waveguide 11. By modelling, according to the geometric features presented above, it has been highlighted that a transmission at least greater than or equal to 95% and preferably greater than or equal to 99%, could be obtained with L1 greater than or equal to 100 μm and L2 greater than or equal to 200 μm.

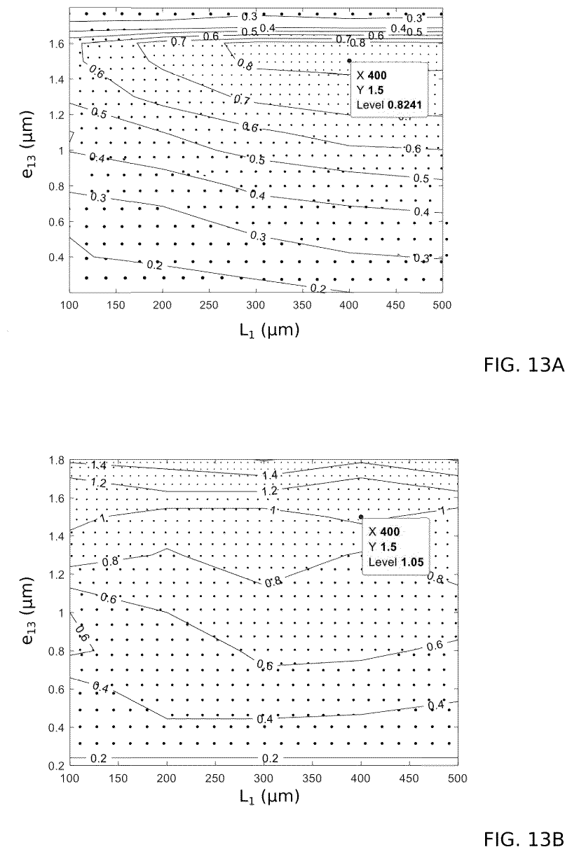

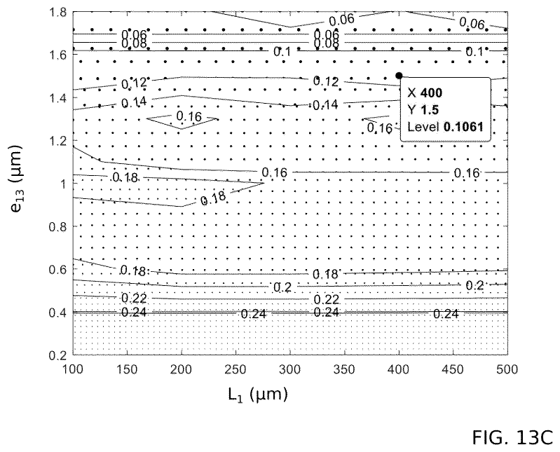

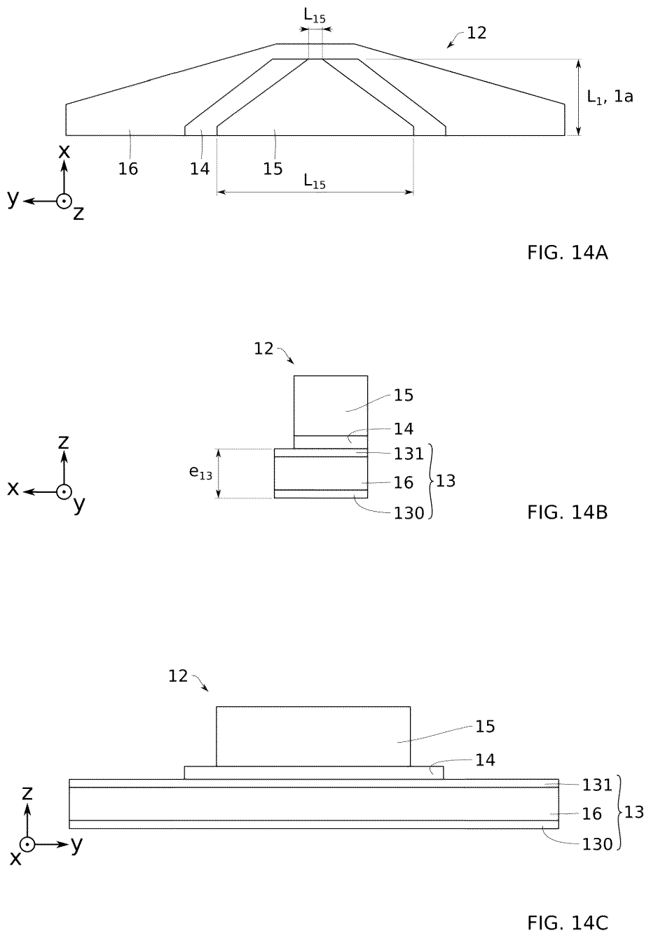

As it is understood from the description above, the geometric parameters can be determined to optimise the transmission of light by successive couplings in the optoelectronic device 1. The interdependences between these parameters can be studied by modelling. To illustrate this, FIGS. 13A to 13C show sizing optimisations of the device 1. The simulations presented in FIGS. 13A, 13B, 13C and the associated diagrams (FIGS. 14A, 14B, 14C) relate to the first transition between the active guide and the intermediate guide 16 (transition zone 1a in FIG. 7), according to an example. For example, FIG. 13A represents the transmission of the first transition 1a according to the thickness e₁₃ of the first layer 13 and of the length L1 of the first transition zone 1a and this, for a geometry comprising a narrower width L₁₅ of the p-InP layer, at the zone between the two transitions of a tapered geometry, substantially equal to 500 nm.

FIG. 13A shows the transmission value of the transition according to the length of it (L1) and of the n-InP thickness (e₁₃) for an optimal value of InGaAsP which can be read in FIG. 13B. For example, for the value presented in the box (transmission of 82.41% for a transition of 400 μm long and an n-InP thickness e₁₃ of 1.5 μm), the corresponding InGaAsP thickness is 1.05 μm.

FIG. 13B shows the optimal thickness of the InGaAsP intermediate layer (of between 0.1.e₁₃ and 0.9.e₁₃) according to the n-InP thickness (e₁₃) and of the length L1 of the transition. For example, for a transition of 400 μm long and an n-InP thickness of 1.5 μm, the simulated optimal InGaAsP thickness is 1.05 μm (box in the figure).

For example, FIG. 13C illustrates the confinement obtained according to the thickness e₁₃ of the first layer 13 and of the length L1 of the first transition zone 1a, according to an example. The fraction of the electrical field covering the stack of the wells and of their barriers is represented in FIG. 13C. In particular, a coverage of 10.61% is obtained for a length L₁ of 400 μm and an n-InP thickness e₁₃ of 1.5 μm (box in the figure). As the wells and their barriers have substantially identical thicknesses, the confinement of the field in the single quantum wells are around half of the value represented, that is 5.3% under these conditions. It is this value which occurs in calculating the gain of the laser.

Plenty of other geometries are possible in addition to those described above. As an example, FIGS. 14A to 14C describe another example of geometry. In this geometry, the width L₁₅ of the second layer is substantially equal to 6 μm. The tip of the second layer 15 has a width L₁₅ substantially equal to 500 nm. The active layer 14 can have an overhang on either side of the second layer 15 over a distance d₁₄ substantially equal to 1 μm. The length L1 can be between 100 μm and 500 μm. The total thickness e₁₃ of the first layer 13 can be between 0.2 μm and 1.8 μm. The intermediate layer 16 can have a thickness e₁₆ substantially equal to 0.1.e₁₃ and 0.9.e₁₃.

The manufacturing method is now described according to a particular example of an embodiment, in reference to FIGS. 15A to 15D. As illustrated by FIGS. 15A and 15B, a stack 18 intended to form the III-V structure 12 can be manufactured on a support substrate 17 by epitaxial growth. The method can comprise sizing steps to determine the thickness of the layers of the III-V structure has formed, according to the methods described above. It is therefore understood that the epitaxial growth steps can therefore be configured to obtain the determined thicknesses.

The method can then comprise at least one step of etching the stack 18 to obtain the III-V structure 12. During this/these etching(s), the second layer 15 and the active layer 14 are etched to form the III-V rod of width L₁₅. Several etching steps can be carried out, such that the active layer has an overhang.

The method can then comprise a transfer of the III-V structure 12 on the substrate 10 comprising the Si waveguide 11, as FIG. 15D illustrates. The substrate 10 can comprise an upper portion 100 based on, or constituted of, SiO₂. The substrate 10 can comprise a lower portion 101 based on, or constituted of, silicon. The method can provide so-called “rear face” steps for the integration of functionalities or of components on the lower portion 101 of the substrate 10. These steps have occurred, preferably, prior to the transfer.

For this, the manufacture of the substrate part 10 can be done upstream. All of these steps can be done upstream. These steps can, for example, include the production of metal levels above the Si waveguide(s), and in particular, to electrically connect the optoelectronic device(s), such as modulators or photodetectors. Thus, the Si waveguides 11 can no longer be accessible through the (upper) front face of the substrate 10. Therefore, instead of transferring the III-V structure 12 onto the upper surface of the substrate 10 (such as is seen in FIG. 2A, for example), the front face of the substrate 10 comprising the Si waveguide 11 can be bonded on a support substrate (typically silicon-based), enabling the handling of the substrate 10. The substrate 10 can be partially etched, thus making it possible to access the rear of the Si waveguide and to integrate the III-V structure coupled to the silicon waveguide, as, for example, FIG. 15D illustrates. The main advantage of this approach is to enable the achievement of a complete photon technology (including, among others, electrical routings), while being compatible with the integration of III-V components (via the rear face).

The invention is not limited to the embodiments described above, and extends to all the embodiments covered by the invention. The present invention is not limited to the examples described above. Plenty of other variants of embodiments are possible, for example, by combining features described above, without moving away from the scope of the invention. For example, in the description above, examples of InP III-V structures are described. Other III-V materials can be considered, and in particular, structures not based on InP, but on AsGa and utilising alloys such as AlGaAs or InGaAs. Furthermore, the features described relating to an aspect of the invention can be combined with another aspect of the invention.

1. An optoelectronic device comprising:
a substrate comprising a silicon-based waveguide having an effective refraction index,
an optically active structure, so-called “III-V structure”, based on at least one III-V material, disposed on the substrate, the III-V structure comprising:
a first layer having a first conductivity of a first type of charge carrier,
an active layer configured to emit or receive a light radiation, and surmounting the first layer,
a second layer having a second type of charge carrier, and surmounting the active layer, the first layer, the active layer and the second layer being configured together to form a first waveguide having an effective refraction index,
wherein the optoelectronic device the III-V structure further comprises an intermediate layer based on of a III-V material configured to form an effective refraction index intermediate waveguide of between the effective refraction index of the first waveguide and the effective refraction index of the silicon-based waveguide, the intermediate layer being disposed between the active layer and the silicon-based waveguide, so as to obtain an optical coupling between the first waveguide and the intermediate waveguide, and an optical coupling between the intermediate waveguide and the silicon-based waveguide.

2. The optoelectronic device according to claim 1, wherein the second layer extends into a main extension plane and has at least one dimension (L₁₅) in said plane greater than or equal to 500 nm.

3. The optoelectronic device according to claim 1, wherein the intermediate layer is based on a material having an effective refraction index of between 3.2 and 3.5.

4. The optoelectronic device according to claim 1, wherein the intermediate layer has a thickness e₁₆ of between 100 nm and 250 nm.

5. The optoelectronic device according to claim 1, wherein the intermediate layer comprises a InGaAsP-based material.

6. The optoelectronic device according to claim 5, wherein the InGaAsP-based material is In₁₋ₓGaₓAs_{y}P_{1-y} with x between 0.1 and 0.4 and y between 0.1 and 0.8.

7. The optoelectronic device according to claim 1, wherein the first layer comprises a first sublayer and a second sublayer surmounting the first sublayer, the intermediate layer being interposed between the first and second sublayers.

8. The optoelectronic device according to claim 7, wherein the first sublayer has a thickness e₁₃₀, the second sublayer has a thickness e₁₃₁, e₁₃₁ being strictly greater than e₁₃₀.

9. The optoelectronic device according to claim 1, wherein, between a first interface between the active layer and the first layer and a second interface between the first layer and the substrate, the first layer has a thickness e₁₃ of between 500 nm and 1500 nm.

10. The optoelectronic device according to claim 1, wherein:
a first portion of the intermediate layer is at least partially superimposed with a portion of the active layer at a first optical transition zone, the first portion of the intermediate layer and the portion of the active layer, each having a width L₁₆, L₁₄, in their main extension plane, decreasing along the first optical transition zone, along a coupling direction (A) parallel or combined with the main extension direction of the silicon-based waveguide by moving away from the III-V structure, the first optical transition zone having a length L1 greater than or equal to 100 μm along the coupling direction (A),
a second portion of the intermediate layer is at least partially superimposed with a portion of the silicon-based waveguide at a second optical transition zone, the second portion of the intermediate layer and the portion of the silicon-based waveguide, each having a width L₁₆, L₁, in their main extension plane, such that:
the width L₁₆ of the second portion of the intermediate layer is decreasing, and
the width L₁₁ of the portion of the silicon-based waveguide is increasing,
along the second optical transition zone by moving away from the III-V structure along the coupling direction (A), the second optical transition zone having a length L2 greater than or equal to 100 μm along the coupling direction (A).

11. The optoelectronic device according to claim 1, wherein the device is a laser, an optical amplifier or an optical modulator or a photodetector.

12. The optoelectronic device according to claim 1, configured to emit or receive a radiation in an infrared light range of wavelength between 800 nm and 2 μm.

13. A method for manufacturing an optoelectronic device according to claim 1, the method comprising:
providing the III-V structure,
integrating by transfer of the III-V structure onto the substrate comprising the silicon-based waveguide.

14. A manufacturing method according to claim 13, further comprising sizing the intermediate layer comprising:
determining a dimension L₁₅ of the second layer in its main extension plane, said dimension being greater than or equal to 500 nm,
the intermediate layer having a thickness e₁₆, determining the thickness e₁₆ according to the dimension L₁₅ of the second layer in its main extension plane,
and wherein the providing of the III-V structure comprises:
an epitaxial growth of the intermediate layer, such that the intermediate layer has the determined thickness e₁₆,
etching of the second layer, such that the second layer has the determined dimension L₁₅.

15. The manufacturing method according to claim 13, further comprising a sizing of the first layer comprising:
determining a thickness e₁₃ of the first layer, taken between a first interface between the active layer and the first layer and a second interface between the first layer and the substrate, enabling the transfer of at least 90% of light between the active waveguide and the intermediate waveguide and between the intermediate waveguide and the silicon-based waveguide,
and wherein the provision of the III-V structure comprises:
an epitaxial growth of the first layer, such that, after transfer, the active layer and the substrate are separated from the determined thickness e₁₃.
